(19) United States
(12) Patent Application Publication
(10) Pub. No.: US 2004/0078281 A1
(43) Pub. Date: Apr. 22, 2004

(54) Product sales apparatus and method

(75) Inventors: Andy Morley, Houston, TX (US); Steve Sidney, Houston, TX (US); David E. Emerson, Sugar Land, TX (US); John V. Kenner, Dallas, TX (US)

Correspondence Address: Timothy M. Donoughue, Winstead Sechrest & Minick P.C., P.O. Box 50784, 1201 Main Street, Dallas, TX, 75250-0784, US

(73) Assignee: Baker Hughes Incorporated, Houston, TX

(21) Appl. No.: 10/277,330

(22) Filed: Oct. 22, 2002

Related U.S. Application Data
(60) Provisional application No. 60/350,141, filed on Oct. 25, 2001.

(51) Int. Cl. G06F 17/60

(52) U.S. Cl. 705/26

(57) ABSTRACT

The disclosed invention provides a system and method for assisting a purchasing user in selecting a good or service from among a host of goods or services offered on a computer network-based purchasing system. The invention comprises a commerce promotion facility, which in turn comprises a server computer and a user computer at the purchasing location, connected to each other via a wide area network. The facility features the ability to assist the purchaser with making a product selection by asking the user a series of dynamic questions. The system is able to use the answers to the questions to limit the possible products offered to the user, greatly enhancing usability of the system. An embodiment particularly for the selection and/or purchase of drilling bits and oilfield services and equipment is disclosed.

### PRIORITY

This application claims priority from the provisional application entitled E-Commerce Product Sales Apparatus and Method filed Oct. 24, 2001, Application No. 60/350,141.

### TECHNICAL FIELD

The instant invention relates in general to an automated system and method for the promotion and sale of goods and services to users via a wide area network, such as the Internet.

### BACKGROUND

Computer networks have proliferated, particularly the global computer network commonly known as the Internet. This proliferation is due to a number of factors, including the increase in available communication bandwidth, the increase in computer hardware capabilities, improvements in computer software, and the reduction in costs associated with each of the foregoing. As a result, many users often have access to computer facilities and communications means, enabling those users to access many facilities remotely as nodes on the network. In fact, these technologies have become so prevalent that it is commonplace for workers to be able to access larger data stores and other sophisticated computerized information directly from their desks.

As a result, there has been an emergence of several models, where purchasers submit orders for goods and/or services over the Internet. One of these models is a business-to-business (or “B2B”) model where businesses purchase supplies and materials on-line. B2B models offer an increasing number of features. Some models will track budgets and accounting. Other models provide catalogs on-line to assist with purchase decisions. The common thread through all of the models is the ability to submit an order directly from the purchaser's desk.

In order for such models function, a common network setup is required. The Internet provides that commonality. The Internet is a global set of interconnected data processing machines and networks that operate based upon the packet-based Transmission Control Protocol/Internet Protocol (“TCP/IP”). Each data processing system, server or node, on the network has associated with it a numeric address (an “IP address”) by which it can be accessed from other data processing systems on the network.

Many improvements in accessibility and security have been made to the Internet. These improvements range from conveniences, such as the provision of “domain names,” which provide users English equivalents for TCP/IP numeric addresses, to more advanced measures, such as Secured Length Layers (“SLLs”) which provide sophisticated password-based access controls to the various notes within the network. Service facilities have also been developed so that high-level coding languages may be used to communicate with common users through a “browsing” interface. These improvements have added to the accessibility and adaptability of the Internet for commerce.

Browsing technology has also become very sophisticated, to the point that many users now enter information, receive customized responses, perform complex searches and full access databases and other information via nodes over the Internet. Powerful languages such as the HyperText Markup Language (“HTML”), JavaScript, JScript, Active Server Page (“ASP”) and other languages act individually or in concert with one another to provide tremendous power and flexibility to programmers. Meanwhile, users experience a more user-friendly interface system with each development.

However, as user-friendly as the Internet systems for the acquisition of goods and services are, they still require that the purchaser have a working knowledge of the goods or services to be purchased in order to make a selection. While this limitation is not significant when a purchaser is buying simple or low-tech goods or services (as a user may be educated very quickly with a help page or the like), the limitation can be quite debilitating for higher technologies.

For example, when a user attempts to purchase a computer through an on-line facility, the typical commerce site will ask the user what kind of processor is desired. The site will also ask the user how much memory is desired, how much hard drive space, etc. However, web sites do not give much guidance for the untutored in the computer arts. Best case scenario, the user is directed to help screens and glossaries to determine the features of some of the available equipment.

Similar problems are encountered when shoppers attempt to purchase oil field tools (bits, casing, etc.), networking and computer equipment (routers, CPU's, etc.), chemical additives (for petroleum products, plastics, adhesives, etc.), proteins, antigens, or any other products where there are a large number of closely-related products differentiated by a large number of characteristics, each having a large range of options. Identical problems are encountered when sophisticated services are differentiated by a large number of characteristics. For example, drilling services (water, natural gas, oil, etc.), vehicle repair, gas separation services, DNA splicing services, etc.

Accordingly, what is needed is a system and method for effectively assisting a user to select sophisticated goods and services offered through commerce web sites. It would be of advantage to the marketplace to offer a high degree of assistance so that users would not be required to be extremely well-versed in the specific good or service purchased in order to effect the purchase for the proper products.

### SUMMARY

The present invention addresses the foregoing needs by providing a system and method for assisting a purchasing user in selecting a good or service from among a host of goods or services offered on a computer network-based purchasing system. While one embodiment of the invention applies specifically to oil field tools (such as drilling bits, casing, coil tubing, packers, wiper plugs, diverter subs, Christmas trees, etc.), the invention is well suited to any goods or services (collectively referred to as ‘products’) in which many different types of product are offered and many different characteristics differentiate the products. By way of example, if a product has only one characteristic, and that characteristic is either present or absent, the instant invention will have little applicability. However, in the instant where there are three or more characteristics, each characteristic having a range of values associated with it, the instant invention will provide a much-improved facility for product selection.

The invention comprises a commerce promotion facility, which in turn comprises a server computer and a node computer at the purchasing user's location, connected to each other via a wide area network (“WAN”). The purchaser identifies himself in any number of ways well-appreciated in the art (such as ID/password entry, cookie presence, etc.). The invention shows a home page on the node which permits the user at least the options of viewing a catalog or purchasing a product.

Should the user opt to view a catalog, an interactive, organized recitation of product information may be provided to the user. The catalog may display to the user a myriad of product information regarding one or several products, including specifications, pictures, drawings, logging data, descriptions and/or marketing text (any of which is referred to as “product information”). The catalog routine has the benefit of the identification of the user, so can point the user particularly to those products that might be of interest to that user. The catalog will also notify either a sales staff or a database of the user's activities.

Should the user opt to purchase a product, the user may elect to have the system provide assistance in product selection. Such assistance will, again with the benefit of the customer identification, retrieve a list of potential products that will meet the customer's criteria. The invention asks a series of prompts for information of the user, with each question narrowing the list of potential products to be offered to the user. At such time as no more questions remain, the user is shown a list of the remaining products from which to select a purchase. The purchase routine will also use this same algorithm in order to select product options, when applicable.

As with the catalog system, the product selection system is integrated to a notification system, where note is made to a sales force and/or a database in order to record the user's movements and selections within the system. These notes may then be used for statistical study or individual customer follow-up.

In one embodiment of the invention, the invention will also pass purchase information into an accounting or billing system so that the customer can be billed. In another embodiment, the invention will pass purchase information on to a fulfillment system to assist or effect the delivery of the goods or services ordered. Combinations of the alternative embodiments are possible as well.

The foregoing outlines broadly the features and technical advantages of the present invention so that the detailed description of the invention that follows may be better understood. Additional features, advantages and preferred embodiments of the invention will be described hereafter which form the subject of the claims of the invention.

### BRIEF DESCRIPTION OF THE DRAWINGS

For a more complete understanding of the present invention, and the advantages thereof, reference is now made to the following descriptions, taken in conjunction with the accompanying drawings, in which:

FIG. 1 is a system diagram of a data processing system, including hardware and firmware, which may be used to implement the instant invention;

FIG. 2 is a flow chart diagram drawn generally in accordance with ANSI/ISO standard 5807-1985 depicting the operation of the instant invention;

FIG. 3 is a flow chart diagram drawn in accordance with ANSI/ISO standard 5807-1985 depicting the operation of the product determination system within the instant invention; and

FIG. 4 is a system block diagram depicting the system configuration of the instant invention, relating the users to the servers and sales force under the instant invention.

### DETAILED DESCRIPTION

In the following description, numerous specific details are set forth, such as computer applications, programming languages, database systems, user interface systems, database structures and implementations, operating systems, network systems, communications systems, protocols, input output (“I/O”) systems, etc., to provide a thorough understanding of the invention to the reader. However, it will be obvious to those skilled in the art that the present invention may be practiced without such specific details and, in fact, that those embodiments described herein may be modified in many details, all falling within the teaching of this disclosure and the appended claims. In other instances, well-known applications, network systems, commerce systems, accounting systems, communications systems, data formats, protocols, personnel classifications and computer equipment have been shown in block diagram form in order to not obscure the present invention in unnecessary detail. For the most part, details concerning timing considerations, specific applications used, specific languages used, specific network or communication systems used, specific web site formats used, specific data formats used, and the like have been omitted inasmuch as these details are not necessary to obtain a complete understanding of the present invention. Moreover, these details are deemed well within the skills of persons of ordinary skill in the art.

It should be understood that, in the context of this disclosure, a “server” or a “server machine” is a reference to a data processing system on a network system which runs a server program, which provides services to other data processing systems, such as access to data, communications routing, order processing, etc. In fact, the data processing system that acts as a server may also run other programs, including programs that interact with and use the services offered by the server program within the network system. Conversely, a “client” or “node” is a data processing system on a network system that runs a client program and may run other programs, including a server program. It is possible, although those skilled in the art will appreciate that it may not be practical in many instances, for a single data processing system to act as a server and a client simultaneously.

Those skilled in the art will also appreciate that, throughout this specification, the terms “data processing system,” “machine” and “computer” are used interchangeably, each having the meaning of a data processing system in the broadest sense and description.

Throughout the specification, the term “user” is also used frequently. While in the computer context, the “user” may be any person or machine operating a data processing system. Within the context of this specification the word is used to denote a customer who accesses the system. “User” may also be a non-customer who operates a data processing system in order to provide goods or services to a customer, such as an outside sales representative, a telephone operator, telephone help line staff, or similar person who uses the system. It should be noted that “user” is not restricted to a human operator, but may include other machines or systems (including artificial intelligence, neural networking and similar systems) which access the data processing system in order to achieve the same goals as the human operator.

The term “select” is used in various forms throughout the specification. When referencing the action of a user, selection may be by any means through which a user elects an option on a data processing system, including without limitation input via keyboard, mouse, trackball, light pen, voice input and recognition or similar means.

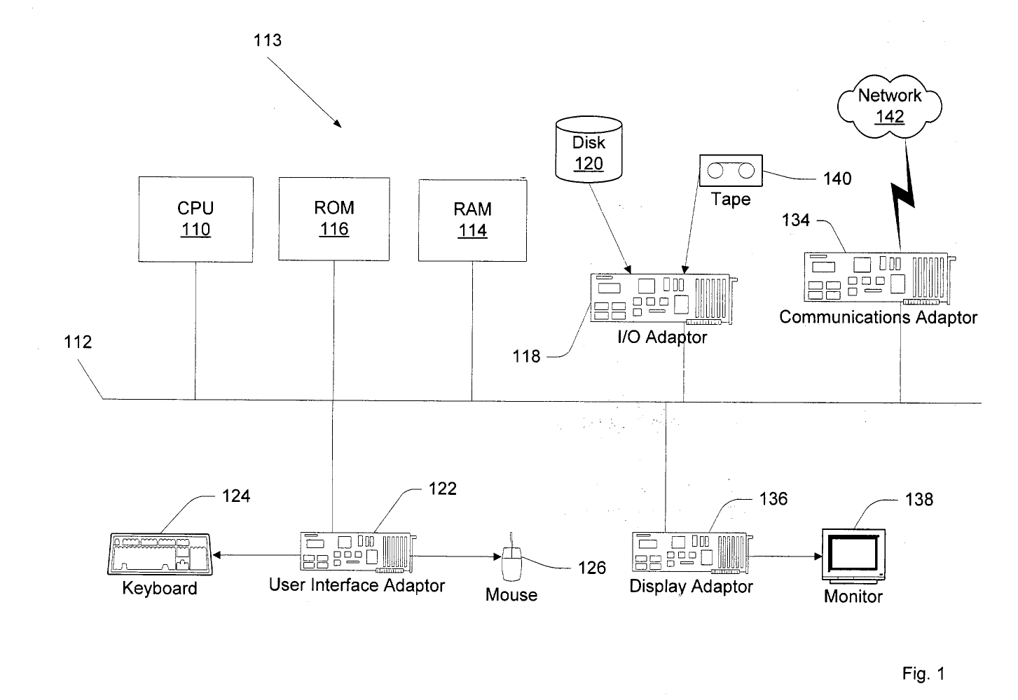

A representative hardware environment for practicing the instant invention and its components is depicted with reference to FIG. 1, which illustrates a hardware configuration of a data processing system 113 in accordance with the subject invention. The data processing system 113 includes a central processing unit (“CPUI”) 110, such as a conventional microprocessor, and a number of other units interconnected via a system bus 112. The CPU 110 may include other circuitry not shown herein, which will include circuitry found within a microprocessor, e.g. execution unit, bus interface unit, Arithmetic Logic Unit (“ALU”), etc. The CPU 110 may also reside on a single Integrated Circuit (“IC”) chip.

The data processing system 113 includes a Random Access Memory (“RAM”) 114 and a Read Only Memory (“ROM”) 116. Also included are an I/O adapter 118 for connecting peripheral devices such as disk units 120 and tape drives 140 to the bus 112, a user interface adapter 122 for connecting a keyboard 124, a mouse 126 and/or other user interface devices, such as a touch screen device (not shown) to the bus 112. The I/O adapter 118 may be of any of several well-know types, including a serial interface, a parallel interface, a Universal Serial Bus (“USB”) and the like.

Further included in the data processing system 113 may be a communication adapter 134 for connecting the data processing system 113 to a data processing network 142. For user interface purposes, the data processing system 113 may include a display adapter 136 for connecting the bus 112 to a display device 138. In an alternative embodiment, the data processing system 113 may include additional display adapters (not shown) for connecting additional display devices (not shown) to the data processing system 113.

It will be appreciated that, although many data processing systems 113 may have many or all of these elements, each and every element described is not required in order for a device to qualify as a data processing system. For example, an Internet terminal may lack the hard drive 120, tape drive 140, or RAM 114 present in the typical data processing system, but the Internet terminal will nonetheless be a data processing system under the instant invention. Similarly, a data processing system under the instant invention may lack other component parts, maintaining the functionality generally described by the data processing system.

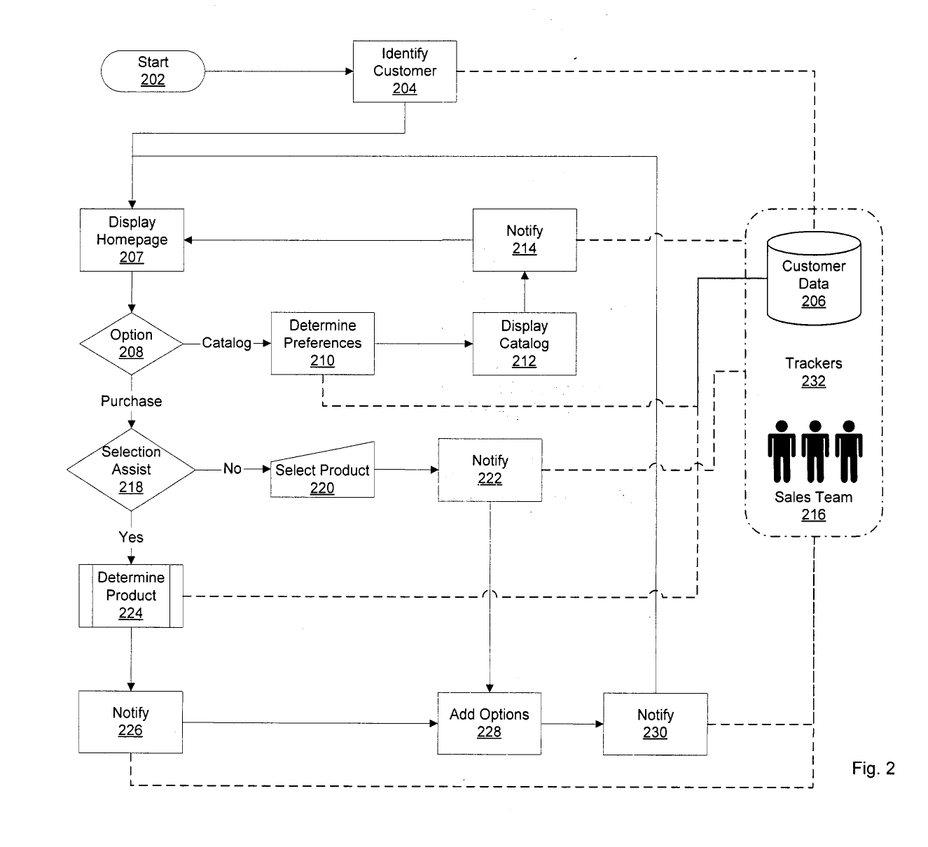

The overall character and operation of the instant invention is demonstrated with reference to FIG. 2. FIG. 2 depicts the process undertaken with respect to the instant invention and accordingly suggests the configuration of the hardware involved.

At the commencement of the invention 202, there is the precondition of a server machine and a node machine at a user's location. While the user location may be the same as the location of the server machine, in most instances the invention will be most useful if the user is located remotely from the server machine. The server machine and the node machine are interconnected via a network. The network may be a local area network, but more frequently it will be a WAN, such as the Internet or such similar facility. Further preconditions are the proper operating system functioning on each machine and some network interaction software, such as an Internet browser on the node machine.

The first step is for the server to identify 204 the customer operating the node machine. Identification can be had through any number of means well-appreciated in the art, such as cookies on the node machine or authentication schemes. Each of the identification processes, however, make reference to a database 206 which stores customer data. The customer database 206 may various elements of data as to each customer, including without limitation the customer's name, company, position, username, password, cookie code, credit history or rating, number of visits to the site, etc.

The system next displays 207 a home page to the user. The home page may be an initial page similar to that on many Internet sites presently. Aside from welcoming the user to the system, the home page also has the function of presenting at least two options 208 to the user: view a catalog or purchase a product.

Should the user elect the view a catalog, the system first determines 210 the user's preferences with reference to the customer database 206. The customer database 206 may contain additional information about the users, such as what kind of products they typically purchase. Based upon the information the system determines 210, the system will display 212 an interactive catalog to the user. The interactive catalog may present, omit or highlight certain materials depending upon the information stored regarding the user. For example, if a certain user usually has an interest in purchasing red marbles (based on past purchases, stated preferences or similar information), the catalog may headline red marbles and show other marbles (perhaps focusing on maroon and pink marbles) in which the customer is likely to show interest.

The catalog displayed is interactive in that it will provide the user additional information on only the products in which the user shows interest. Navigation through the interactive catalog may be accomplished by any selection means, such as clicking on a link, selecting a number corresponding to a menu selection or similar selection modes.

As or after the user has viewed the displayed 212 catalog, the system notifies 214 one or more of an external group of trackers 232. The purpose of the trackers 232 is to monitor the user's use of the system. Tracking may take place by submission of entries into the customer database 206, supplementing the information available on the customer's interests. Information sent to a database may be later retrieved for statistical study. Tracking may also take place by transmission of data (via e-mail or other notification means) to a sales team 216 for follow up or other action. The customer database 206 and the sales team 216 may interact, so that the sales team 216 has the benefit of the data collected in the customer database 206 when the sales team calls on various customers. According, the word “tracker” is used in its broader sense and includes salespeople, analysts, product specialists, auditors and other people as well as means for recording or memorializing data, such as databases, printouts, listings and the like.

After the interactive catalog notifies 214 the trackers 232, the system once again returns the customer to the display 207 of the home page. The customer is once again given the option 208 to view the catalog or to purchase a product.

Upon selection to purchase a product, the user is prompted as to whether he would like assistance 218 in selecting the product to purchase. If the user elects not to utilize the assistance features, execution proceeds directly to the user selecting 220 the bit. Selection 220 may be accomplished by any means well-known and appreciated in the art, as set forth earlier in this specification. After selection 220, a notify 222 routine similar to the earlier notify 214 process is undertaken, recording the purchase selection with the trackers 232.

After notification 222, the system may allow the user to add options 228 to the selected product. The add options 228 routine may be intelligent, offering only those options which are appropriate to the product selected 220. The add options 228 selection may also take into account information among the customer data 206 which was retrieved during the customer identification 204 process. The user selects add-on options 228 in the typical manners, well-known in the art. Again the trackers 232 are notified 230 of the selections, so that the system permits follow-up and statistical analysis of purchases and attempted purchases. After notification 230, the user is returned to the system homepage 207.

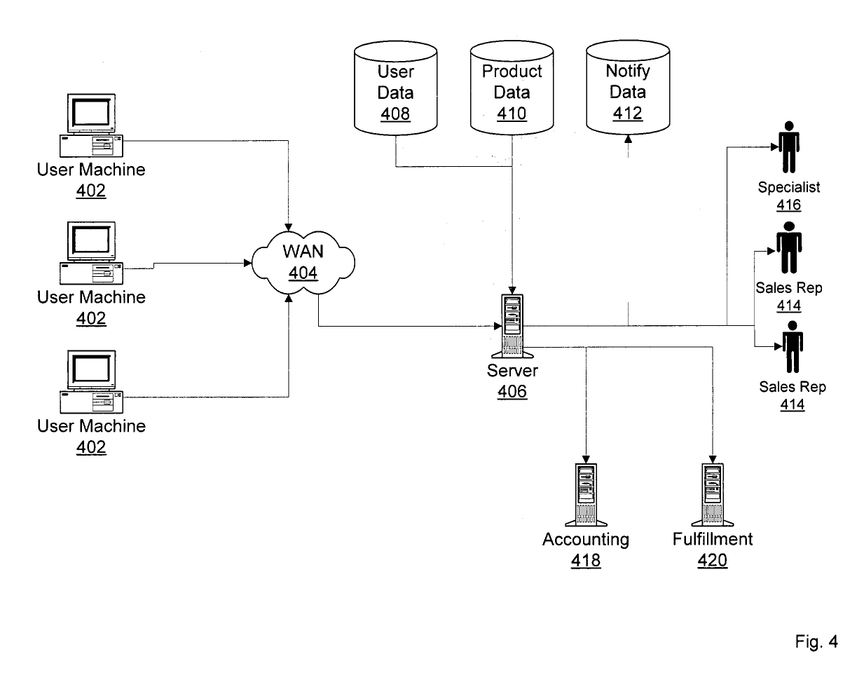

If the user elects to utilize product selection assistance 218, the system utilizes the product determination system 224 to select the product. The product determination may be implemented in a separate routine, later illustrated in FIG. 4.

Once the system has assisted the user in selecting the product, the system notifies 226 the trackers 232, as with the other phases of the system. Execution continues with the user being able to add options 228 to the product. As described earlier, it is anticipated that the option selection 228 process may be intelligent, utilizing the customer information and/or the product selected (at 224) to offer only the applicable options. Notification 230 follows, informing the trackers 232 of not only the results of the determination, but also any specific issues the trackers 232 elect to track (such as answers to specific questions, etc.).

In an alternative embodiment, the add options 228 step and the accompanying notification 230 may be skipped (when the selection assistance is used, when it is not used or both), for example when no options are available or when the product selection and customer information dictates that no options should be given.

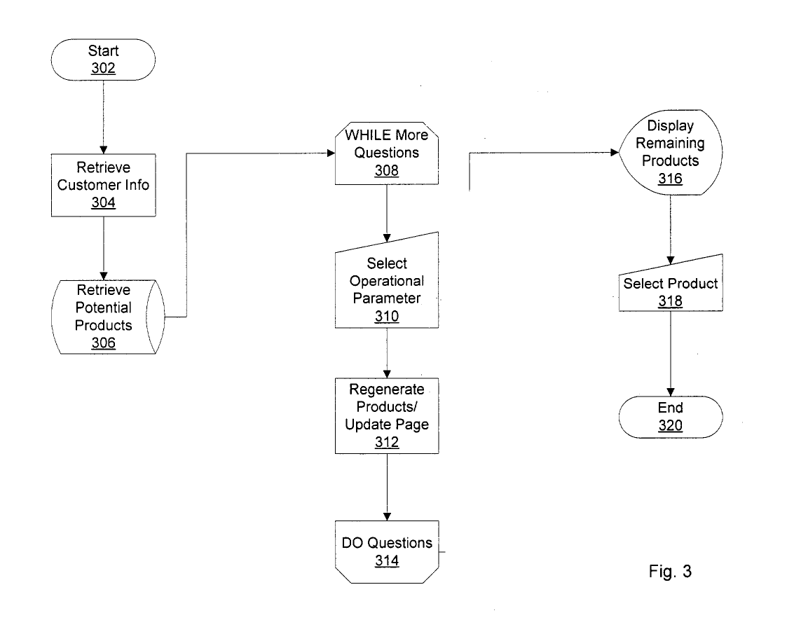

Detail of the automated product selection assistance routine 224 is given with reference to FIG. 3. The system begins 302 with the precondition of an on-line potential customer who desires assistance with selection of a product.

The system first retrieves the customer's information 304 from the customer database (not shown). The customer information retrieved may be used as the basis for some or all of the remainder of the process. The system next retrieves a listing of the potential products 306 that might be purchased by the user. Frequently, this list will be the entire product line offered. In an alternative embodiment, the list retrieved might be only the products that meet the customer's profile information retrieved 304 by the system. For example, if the client database profile indicates that the user only purchases products that are bigger than a breadbox, than only the products that fit that size requirement may be retrieved.

The system then commences a loop 308 dependent upon a series of prompts to be presented to the user. Each prompt may be a question or other request for information from the user. During each iteration of the loop 308, the system presents a prompt to the user designed to select an operational parameter of the product 310. For example, if the product is a vehicle, one of the prompts might be to ask the user whether the vehicle to be purchased would haul large objects. If the user answers yes, then that answer may suggest an operational parameter of “truck” versus “automobile” for the vehicle. Similarly, the operational parameter may be selected through a combination of prompts, where the answers to the several prompts in combination suggest certain parameter selections.

The system prompts 310 the user with reference to a knowledge database (not shown) which maintains a list of the prompts useful to narrow the field of products and determines the correct effect of the responses to the prompts.

Once the operational parameter is selected 310, the system regenerates the potential products list 312 to include only the products which continue to meet the criteria suggested by the client database information and the selected operational parameters. Those skilled in the art will recognize that regeneration of the list may occur in any of several manners. The potential products list may be narrowed to remove some products based upon the operational parameter. Alternatively, the potential products list may be entirely re-analyzed or researched. Further, in another alternative, the potential products list may be added to based upon the response to the prompt, but the reader will appreciate that this alternative must be used in conjunction with one of the other alternatives in order to provide a conclusion (and narrowing) to the iterative loop that results in a narrowed list of products. Once the list is regenerated, the page on which the questions are put to the user is updated to reflect the new list.

In one embodiment of the invention, the entire list is not shown to the user until its size reaches a manageable number of products (e.g. fewer than 20). In another embodiment of the invention, the questions posed to the user are dynamic, being modified based upon the prior questions answered. For example, one inquiry may be to ask the user in what country the product will be used. If the user selects “United States,” then the user will be prompted to answer in what state the product would be used, being provided with a list of the 50 states from which to chose. However, if the user selects “Morocco,” then the user will not be prompted for a state. Similarly, if the user selects “Canada,” the user will be prompted the providence and provided the appropriate list.

By properly formulating the list of questions (including appropriate dependencies for dynamic questioning), the system operates as a product specialist or engineer. This formulation is reflected in the knowledge database. The questions may be advanced and cover such areas as budgetary restrictions, locale in which the product is to be used, duration of the anticipated use, problems experienced with previously-used products, physical conditions at the location of use, contractor requirements (small business, minority owned business, etc.), and similar inquiries. The nature of the product, its complexities, its variables, and the factors typically used by human selectors all factor in to the number and type of questions which are optimally used by the system to locate products.

The iterative loop 308 repeats 314 for each question to be posed to the user. When no questions remain, the loop 308 terminates 314.

Next the system displays 316 a list of the products remaining in the product list. As the overall list has been narrowed through the iterative loop process 308, the list displayed 316 contains only qualifying products that will meet the users needs and budgetary restraints (assuming that budget was one of the questions posed to the user in the loop 308). The user may then select 318 one of the products listed.

Post-conditions 320 of the operation include the identification of the selected product. The identity of this product can then be passed back to the calling routine for further processing.

The operation of the system and its interaction with other systems is demonstrated with reference to FIG. 4. The bulk of the programming which causes the operation of the instant invention system resides on a server 406 which is in communication with a WAN 404, such as the Internet or other widely-available communications network. The WAN 404 is in turn connected to at least one user machine 402, from which the users access the system.

The user machines 402 may be any type of data processing system. Its connection to the WAN 404 may be by any of several means, well-appreciated within the art, such as dialup connection through an Internet Service Provider (“ISP”), Digital Signal (“DS”) circuit (also commonly known as a “T-carrier line”), Integrated Services Digital Network (“ISDN”), Digital Subscriber Line (“DSL”). While this connection may be dedicated to operation of the instant invented system, optimally the system will have the advantage of being able to use an existing connection schema used for other purposes (such as Internet Web browsing, real-time monitoring, e-mail, etc.). It should be noted, however, that a high-speed connection between the user machine 402 and the WAN 404 will decrease the response time of the system as a whole and provide a more efficient interface for the user.

The WAN 404 may operate on any number of protocols, including without limitation the currently-popular TCP/IP protocol. It should be recognized that the instant invention operates independently of the networking protocol in operation, all of the operations occurring at a level superior to the networking protocols. Accordingly, network operations may be transparent to the operation of the instant invention, and the networking protocols may be adapted to other purposes in addition to their uses within the instant system.

The server 406 central to the system comprises a data processing system configured in accordance with the foregoing descriptions. Although the server 406 is depicted (and referred to in the singular) as a single data processing system, those skilled in the art will recognize that the operations of the single server could be implemented in several servers, all falling within the scope of the invention. For example, the catalog functions may be implemented in a different data processing system from a second data processing system which actually affects the sales of the products, the two data processing systems collectively being the server 406. Similarly, multiple data processing systems could be used to divide load based upon number of users (or number of operations or some other similar standard), rather than a division based upon functions performed by the server 406. Each of these variations would be readily apparent to those skilled in the art and fall within the disclosure of the instant invention.

The server 406 is in data communication with a user database 408. The user database may be implemented through a separate data server data processing machine or through a hard drive or other storage medium stored within the data processing machine which performs the server 406 functions. The purpose of the user database 408 is to store the information relating to the user, such as identification and credit information. The information may be placed in the user database 408 via direct data entry, or that information may be updated automatically through input from the user at the user machine 402 (as directed through the WAN 404, to the server 406 and out to the user database 408). In the alternative, a sales representative 414 or other employee of the seller may modify the user data 408.

The server 406 is also in data communication with the product database 410. Similar to the user database 408, the product database 410 is a separate data processor or other storage medium which stores information relating to the products to be offered through the system. The product data 410 may comprise prices, features, photographs, sound samples, specifications, and other information regarding the products. The product data 410 may be entered and/or modified by direct entry, as with the user data 408. Unlike the user data 408, however, the product data 410 would not be modifiable by the users at the user machines 402, who would access the data on a read-only basis. Product data 410 could also be modifiable by certain sales representatives 414 or other company representatives, so that product lines would be updated to match offerings.

The server 406 also is in data communication with the notify data 412. The notify data 412 is stored within a database, or, alternatively as with the other databases with which the server 406 interfaces, within the server 406 in a separate data area (file, disk or other media). In some embodiments, it will be possible and advantageous to have the user data 408, the product data 410 and the notify data 412 stored within a single logical database, within a single data processing system or both. However physically or logically stored, the notify data 412 is the data created by the server 406 during the operation of the system to provide a basis for later analysis of customer and potential customer use of the system. The notify data 412 may also be accessed by company personnel, such as the sales representatives 414 or specialists 416 in order to provide sales service to the customer or potential customer.

The server 406 is also in data communication with the sales force, comprising sales representatives 414 and product specialists 416. These are the personnel designated to receive the alerts generated by the system. Ideally, the sales representatives 414 and the specialists 416 are in a position to assist customers with purchase decisions, with problems they encounter with the system, and with questions that might arise during the purchase process. Accordingly, if a user is confused by one of the questions posed by the system and exists the user interface on the user machine 402, the fact of that exit may be recorded in the notify database 412 and an alert may be sent to a sales representative 414 to follow up with the client for manual entry of the order. Similarly, if a user answers a set of questions for the system that selects a product (given the product data 410) which would be very unlikely given the user's profile as established by the user database 408, the system may send an alert to a product specialist 416 to follow up with the client to confirm that none of the questions were answered in error and that the proper product was indeed selected.

The product specialists 416 and the sales representatives 414 may also be given the ability to access the notify data 412 through the server 406 (or, in an alternative embodiment, directly), in order to view and/or download the data stored there. This data would be useful to the product specialist 416 and the sales representative 414 in performing marketing studies, preparing presentations for the users (being able to see what the user has accomplished on the system during the process), or any similar marketing uses.

The server 406 may also be in data communication with the accounting system 418 employed by the company housing the system. The connectivity to the accounting system 418 permits the system the ability to automatically add billings to be generated (and subsequently added to accounts receivable statements) into the accounting system 418. In an alternative embodiment, the server 406 may serve as a pass through or a pointer to the accounting system 418 to permit a user at a user machine 402 to access accounting information for the user's account and make payments on-line.

The server 406 may also be in data communication with a fulfillment system 420, whose function it is to affect an order placed through the server 406. While it is possible that orders placed through the system may be simply sent to a sales representative 414 after selection or sent to a database in place of the fulfillment system 420, the optimal use of the system would enable it to incorporate direct access to order fulfillment upon order entry. The fulfillment system 420 may comprise a data processing system merely storing the orders for future fulfillment. In an alternative embodiment, the fulfillment system 420 may be a data processing system integrated into an automated fulfillment system. Those skilled in the art will appreciate that a range of fulfillment systems may be used with the instant system.

As to the specific manner of operation and use of the present invention, the same is made apparent from the foregoing discussion. However, for the sake of clarity, several key applications of the invention are highlighted. The foregoing invention includes applications for the sale or provision of tools for wells and drilling applications, including bits, packers, cementing apparatus, Christmas trees, rotary tables, casing, threadings, coil tubing, and the like. The foregoing invention also includes applications for the sale or provision of drilling mud and drilling fluids, oils, gases and similar consumables.

With respect to the above description, it is to be realized that although embodiment of specific material, representations, iterations, applications, product configurations, networks, and protocols are disclosed, those enabling embodiments are illustrative and the optimum relationship for the parts of the invention may include variations in composition, form, protocols, function, and manner of operation, which are deemed readily apparent to one skilled in the art in view of this disclosure. All relevant relationships to those illustrated in the drawings and the specification are intended to be encompassed by the present invention.

Therefore, the foregoing is considered as merely illustrative of the principles of the invention. Numerous modifications will readily occur to those skilled in the art. It is not desired to limit the invention or the claims to the exact construction and operation shown or described, and all suitable modifications and equivalents may be resorted to, falling within the scope of the invention.

What is claimed is:

1. A system for promoting commerce comprising:
a first user;
a server in data communication with a network;
a node in data communication with the network;
a user database in data communication with the server;
a product database in data communication with the server;
a notification database in data communication with the server; and
a second user,
wherein the first user accesses the node,
wherein the node communicates with the server through the network,
wherein the server identifies the first user in communication with the user database,
wherein the server provides product information from the product database to the node, and
wherein the server notes the first user's access in the notification database for use by the second person.

2. The system of claim 1 wherein the second person is a member of the group essentially consisting of a salesperson, an information technology person, a marketing person, an analyst, a supervisor, an auditor or an agent.

3. The system of claim 1 further comprising a database server in data communication with the network,
wherein the database server contains and manages the user database.

4. The system of claim 2 wherein the network comprises a wide area network.

5. The system of claim 1 further comprising a database server in data communication with the network,
wherein the database server contains and manages the product database.

6. The system of claim 1 further comprising a database server in data communication with the network,
wherein the database server contains and manages the notification database.

7. The system of claim 1 further comprising an accounting server in data communication with the network,
wherein the server accepts a purchase transaction, and
wherein the accounting server processes the financial aspects of the purchase transaction.

8. The system of claim 1 further comprising an implementation server in data communication with the network,
wherein the server accepts a purchase transaction, and
wherein the implementation server facilitates the fulfillment of the purchase transaction.

9. The system of claim 1 wherein the server provides the information from the product database to the first user in an organized format.

10. The system of claim 1 wherein the server provides the information from the product database on the basis of the information contained in the user database.

11. The system of claim 10 wherein the information the server provides to the first user from the product database is a subset of the information in the product database.

12. The system of claim 111 wherein the subset is selected with reference to the first user's response to a prompt posed through the node.

13. The system of claim 12 wherein the server dynamically poses a series of prompts to the first user through the node, the answers to which are used to facilitate selection of the subset.

14. The system of claim 13 wherein the series of prompts are issued to the first user with reference to a knowledge database.

15. The system of claim 13 wherein the network comprises a wide area network.

16. The system of claim 1 wherein the second user provides additional follow-up information to the first user based upon the information in the notification database.

17. The system of claim 14 wherein the second user provides additional follow-up information based also upon the information in the user database.

18. A method for facilitating sales to a user using a computer network having a server and a node comprising the steps of:
identifying the user;
displaying a home page to the user;
providing the user a product determination method to select a product; and
notifying a tracker of the product selected.

19. The method of claim 18 further comprising the step of permitting the user to add options to the product following its selection.

20. The method of claim 18 wherein the tracker comprises a member of the group consisting essentially of a tracking database, a salesperson and a technician.

21. The method of claim 18 further comprising the steps of:
determining the user's preferences;
displaying catalog information to the user;
providing additional information to the user based upon the user's selections from the displayed catalog information; and
notifying the tracker of the information the user selected.

22. The method of claim 18 wherein the product determination method comprises the steps of:
retrieving user information from a user database to select a selection group of products from a products database;
executing an iterative looping process wherein the steps of:
presenting a prompt to the user based upon the contents of the selection group;
receiving an answer from the user; and
regenerating the selection group based upon the answer,
until such time as no further questions remain to be asked;
displaying the selection group to the user; and
receiving a selection of one of the selection group from the user.

23. The method of claim 22 wherein the step of presenting the prompt further comprises the step of selecting the prompt from a knowledge database.

24. The method of claim 20 wherein the product determination method comprises the steps of:
retrieving user information from a user database to select a selection group of products from a products database;
executing an iterative looping process wherein the steps of:
presenting a question to the user based upon the contents of the selection group;
receiving an answer from the user; and
regenerating the selection group based upon the answer,
until such time as no further questions remain to be asked;
displaying the selection group to the user; and
receiving a selection of one of the selection group from the user.

25. The method of claim 23 wherein the product is more particularly a service.

26. A computer program product in a computer-readable medium adapted to promote the sale of a product to a user, the computer program product comprising:
an identifying code comprising a set of codes operable to identify the user;
a product determination code comprising a set of codes operable to provide the user a method to select the product; and
a notification code comprising a set of codes operable to notify a tracker of the product selected.

27. The computer program product of claim 26 further comprising an option adding code comprising a set of codes operable to permit the user to add options to the product following its selection.

28. The computer program product of claim 26 wherein the tracker comprises a member of the set essentially comprised of a tracking database, a salesperson and a technician.

29. The computer program product of claim 26 further comprising:
a preference code comprising a set of codes operable to determine the user's preferences;
an interactive catalog code comprising a set of codes operable to display catalog information to the user and to provide additional information to the user based upon the user's selections from the displayed catalog information; and
a notification code comprising a set of codes operable to notify the tracker of the information the user selected.

30. The computer program product of claim 26 wherein the product determination code comprises:
a user information code comprising a set of codes operable to retrieve user information from a user database and, based thereon, to select a selection group of products from a products database;
a looping code comprising a set of codes operable to repetitively execute the steps of:
presenting a question to the user based upon the contents of the selection group;
receiving an answer from the user; and
regenerating the selection group based upon the answer,
until such time as no further questions remain to be asked;
a selection display code comprising a set of codes operable to display the selection group to the user; and
a user selection code comprising a set of codes operable to receive a selection of one of the selection group from the user.

31. The computer program product of claim 26 wherein the product determination code comprises a set of codes operable to perform the steps of:
retrieving user information from a user database to select a selection group of products from a products database;
executing an iterative looping process wherein the steps of:
presenting a question to the user based upon the contents of the selection group;
receiving an answer from the user; and
regenerating the selection group based upon the answer,
until such time as no further questions remain to be asked;
displaying the selection group to the user; and
receiving a selection of one of the selection group from the user.
